(19) United States
(12) Patent Application Publication
(10) Pub. No.: US 2007/0220042 A1
(43) Pub. Date: Sep. 20, 2007

(54) Note Overlay System

(75) Inventors: Raymond J. Mueller, Palm Beach Gardens, FL (US); Andrew S. Van Luchene, Santa Fe, NM (US); Dean Alderucci, Westport, CT (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/697,480

(22) Filed: Apr. 6, 2007

Related U.S. Application Data
(63) Continuation-in-part of application No. 11/462,621, filed on Aug. 4, 2006.
(60) Provisional application No. 60/727,191, filed on Oct. 14, 2005.

(51) Int. Cl. G06F 7/00

(52) U.S. Cl. 707/102

(57) ABSTRACT

A system of maintaining notes associated with documents that may be, for example in a document database, such as a patent database, is described. The notes may be submitted by the author(s) of the original document, by parties associated with the original document (such as a patent examiner), or by a third party. Access to the notes may be limited based, for example, on a party's relationship to the original document.

### CROSS REFERENCE TO RELATED APPLICATIONS

The present application is a continuation in part of U.S. patent application Ser. No. 11/462,621, “Fee-Based Priority Queuing for Insurance Claim Processing” filed Aug. 4, 2006, which claims the benefit of U.S. Provisional Patent Application No. 60/727,191, filed Oct. 14, 2005, each of which is hereby incorporated by reference.

### BACKGROUND OF THE INVENTION

Protecting intellectual property through patent systems is a vital part of most countries' national economies and well as the global economy. However, many patent systems are facing a number of challenges due to the increased technical complexity of patent applications as well as with the challenge of hiring and training new patent examiners to cope with the increasing number of applications being filed.

In 2000, 311,807 patent applications were filed in the U.S. This number increased to 409,532 applications in 2005. Globally, 145,300 applications were filed under the Patent Cooperation Treaty in 2006, representing a 6.4% growth over the previous year. This trend has held steady since 1995 with the number of applications filed increasing every year.

The problems in the protection of intellectual property rights are further compounded by virtual reality games. Hundreds of thousands of players access games known as massive multi-player online games (MMOGs) and massive multi-player online role playing games (MMORPGs). Players of these games customarily access a game repeatedly (for durations typically ranging from a few minutes to several days) over a given period of time, which may be days, weeks, months or even years. Many of these games purport to give intellectual property rights to the players in their virtual creations. However, these games lack a structured system for evaluating and granting such rights.

Given the increasing number of applications being filed and the increased demand for protection of intellectual property, it would be advantageous to provide alternate methods for assigning and distributing applications for examinations. Such alternate methods would relieve some of the pressure on patent systems, allowing examiner's to focus on the aspects of their duties that require human involvement.

### DETAILED DESCRIPTION

According to one embodiment, a system is provided to allow end users to attach notes into an electronic document. As used herein, the terms “document” or “electronic document” may include any human-viewable representation of data including, for example, text documents, source code, machine code, screen snapshots or captures, photographs, word documents, words, newspaper, magazine and other articles, white papers, blogs, technical manuals, online and other catalogs, web sites, web pages, survey questions and responses, patent applications, including any pending, published and/or issued patent(s), diagrams, figures, Information Disclosure Statements, databases of electronic information, images, graphics, software applications, or modules, including graphical user interfaces, software or code, source or object code, forms, such as insurance forms, queues, e.g., a list of patents to be processed, office actions, examiner notes, and other notes, hyperlinks, computer files and other electronic media and/or content and/or data. It should be noted, that in order to qualify as a document, the human-viewable data need not be comprehensible, over even necessarily readable, as might be considered the case, for example, of a document displaying machine code.

In some embodiments, the notes may be specifically associated with only a subset of the viewable data in the document. For example, the note may be associated with one or more words or phrases in the document. Moreover, the note may be associated with one or more hyperlinks and/or may contain hyperlinks therein.

According to various embodiments:

Advertisement—includes any communication via any medium to any one or more end users or any person or third party. Advertisements may include text, audio, video, icons, graphics, images, etc. Advertisements may include an offer for sale, for profit or not, and may or may not include a discount, for any services, products, financial instruments, e.g., insurance, annuities, securities, e.g., stocks, bonds, options, etc. and/or any other good or service, and/or may provide information about any of the forgoing or anything, such as a request for donations to political or charitable or any other entity or organization. Or, an advertisement might be used or designed to provide information to inform or educate any constituent and/or may include communications in support of any one or more objectives such as public relations, publicity, product placement or introduction, sponsorship, underwriting, public notice or service announcement or any other objective or purpose.

Alert—includes the transfer, delivery or storage of information or otherwise communicating with, by, between or among any two or more of the following, including, but not limited to any real or virtual: a) end user, b) game owners, c) game or other servers, d) player or player characters, e) NPC's, f) exchanges, g) game devices or controllers, h) cell phone or other communications hardware and/or networks, i) databases, j) software applications, k) legal agencies, l) governing bodies, m) software interfaces, n) any person, o) and/or any combination of any of the above, which may be initiated by and/or based upon an alert event or other action. Exemplary methods to determine alert events and/or to send alerts are disclosed for example, in U.S. patent application Ser. No. 11/676,848 “Virtual Environment with Alerts” filed Feb. 20, 2007 which is incorporated herein by reference.

Alert Event—includes any change in, of or to any condition or state, and includes any action, opposite action, unexpected action, desire for action, or failure to act, and thus Alert Event includes, but is not limited to any one or more of:
1. When or after any one or more variables or data changes or is expected or is about to change within an application, service, API, communications network or one or more databases, or database variables or element, e.g., a balance is reached or exceeded
2. When an end-user acts, e.g., clicks on a word or link, or fails to act as or when expected.
3. An amount of time elapses with or without an action.
4. When or after information is transmitted and/or shared (e.g. via a communications package or other mechanism) between two or more applications, services, servers, financial institutions, or any other entities, e.g., a message sent between two servers to provide information about one or more hyperlinks.

Approval Queue—includes a queue of documents and or prior art associated with those documents that is awaiting an approval mark from an entity such as a patent examiner

Boilerplate—includes any text, word, words, or phrases and/or part or all of a document which may be readily or otherwise reused with little or no modification and/or to serve as the basis of a new phrase or document, which use may save time and effort in the creation of said phrase or document. Boilerplate may include standard documents, terms, conditions, words, phases, etc., that can be incorporated or reused in multiple applications.

Blog—includes a user-generated website or other system where entries may be made in journal or other style and may be displayed in a reverse chronological or other order. Blogs often provide commentary or news on a particular subject, such as food, politics, or local news; some function as more personal online diaries. Blogs may include and/or combine or use text, images, and may include links, including hyperlinks to other blogs, web pages, documents, words, and other media related to its topic or subject matter. The term “blog” is derived from the term “Web log.” “Blog” can also be used as a verb, meaning to maintain or add content to a blog.

Certified Component—includes any piece of software that is a component of a total software solution that has been approved for use by an entity such as the USPTO

Certified Definition—includes the definition of a word or phrase as it relates to a class or subclass of patentable inventions that is approved by an central entity such as the USPTO

Certified Font—includes any font that is approved by a central entity such as the patent office for use in an invention disclosure or figures associated with such a disclosure.

Certified Icon—includes any icon that can be used in a figure to be submitted with a patent application to identify a standard component of invention that is approved for it use by a central entity.

Certified Plug-in—includes any software module that can be inserted into a larger software program and used to perform a sub function of the total function of the total system that is approved by a certification party such as the USPTO

Certified Shape—shall include any visual shape that can be used to identify a component in a patent or other drawing that is approved by a central entity such as the patent office for use in a figure associated with an invention disclosure

Certified Template—shall include a group of certified shapes, certified Icons, and or certified fonts that can be used in a figure associated with an invention disclosure and that is approved by a central entity such as the patent office.

Class, in the context of a patent application, —includes a class of patents or other digital documents in an electronic database

Click-through—includes the process of an end user selecting or otherwise activating a hyperlink

Document Map or Map—includes a visual representation of a group of documents or other items or objects, such as patents that shows the relationship of those documents, objects or items to one another. For example, a map might be of a group of documents and their relevancy to each other. Or, a map might include a visual representation.

End User—includes any person or entity, real or virtual that makes use of or otherwise practices any part or all of the disclosed invention and/or any software application or tool disclosed herein or otherwise. End users include, for example, patent applicants, patent examiners, patent attorneys, patent examiner supervisors, document review specialists, diagram or figure design engineers, survey respondents, search tool users, and other persons. In certain embodiments, an end user may be an application, application program interface, reporting or other tool or automated process.

Genetic Algorithm—includes any software application or module that can improve results with use.

Hyperlink or link—includes a set of instructions or code, which may be embedded, or otherwise associated with or connected to, an element, word, object, icon, document, figure, map, file attachment, or other displayed area within a document which, when selected, clicked or otherwise activated by an end user, may cause a computer to perform one or more functions. Examples of functions that might be performed include, but are not limited to, displaying new or additional information, redirecting to a different area of the same or a new document, displaying an advertisement, soliciting and/or capturing information, opening a form that requires end user input, and/or displaying new information that is generally associated with and/or related to the hyperlinked element. New or additional information and/or webpage(s) may or may not be displayed using a separate or new web browser page or popup window or interstitial. Hyperlinks are commonly identified through the use of an underline and/or color coding, e.g., HYPERLINK, but this is not necessarily required or desired. Hyperlinks may be activated by any applicable means, including, but not limited to, left or right clicking on or near the link, placing a pointer on or near the link (briefly, temporarily or not), touching the area, e.g., via use of a touch screen or other pointing mechanism, and/or automatically, e.g., based upon date or time, or other action or inaction of the end user. For example, in some situations, failure to respond within a given timeframe may cause execution or delay of execution of a hyperlink. A hyperlink may be associated with other hyperlinks, e.g., hyperlinks within hyperlinks, documents, programs, words, phrases, or other information or actions. For example, if an end user right clicks on a hyperlink, one or more options may appear, permitting the end user some degree of flexibility in the action or actions taken. The terms link and hyperlink shall have corollary meanings.

Information Disclosure Statement (IDS)—includes the definition provided by the United States Patent and Trademark Office (USPTO).

IDS Report—includes a document that references all prior art material associated with a patent application or invention disclosure

Image—includes figures, pictures, drawings, document images, e.g., document snapshots, etc.

Improvement Module—includes a sub module that is embedded in a total system that is used to improve upon the total system or other sub modules embedded in that system.

Keyword—includes any word or words that are identified as being “of interest.” A keyword may be of interest because it is a word that generally helps to describe the content of the document in which it is used, or for other reasons.

Lexicon—includes a group of words with corresponding definitions that is broken into classes and subclasses that are associated with the class and subclass of documents in a database such as the digital database of filed and or issued patents of the USPTO

Mapping—includes the process of associating documents to one another and providing a visual representation of the relationships of those documents.

Merchant—includes any person that desires to sell a good or service or desires to have one or more end users to review, select, or click a hyperlink in a document and/or receive other information and/or perform other tasks and/or receive information associated with one or more keywords selected by such merchant.

Notes—includes any computer file or data or any free form or other text, graphics, figures and/or any files such as any audio, video, e.g., JPEG or MPEG, pictures, e.g., GIF, or other files, such as, PDF, XLS, XML, TXT, DOC, RTF, or any other known files such as those described on the websites: http://filext.com/ and http://www.computeruser.com/resources/dictionary/filetypes.html, which are incorporated herein by reference. Notes may be attached or associated with any one or more of the following, any electronic element, word or words, phrase, document, figure, hyperlink, webpage, database, table, file, or any other electronic media. Notes may include any description, hyperlink, figure, document or file associated or attached to any of the forgoing and/or any combination of the forgoing. In certain embodiments, notes may contain or refer or reference other notes, e.g., notes within notes.

Patent Application—includes an invention disclosure that has been filed with a registration entity such as the USPTO

Patent Application Drafting Tool—includes a web based software program that assists in the drafting and filing of patent applications with a registration entity such as the USPTO. An exemplary patent application drafting tool is described in U.S. patent application Ser. No. 11/627,263, which is hereby incorporated by reference.

Patent Drafting Engine—includes a software module that can partially or completely draft and/or modify an existing draft patent application and/or file those applications with a registration entity such as the USPTO.

Patent Figure—includes any figure or document attached to a patent application

Patent Section—includes any section of a patent application or invention disclosure such as the background, summary, title, abstract and or claims.

Patentability Score—includes a score assigned by one or more people, e.g., an end user, or computer programs to a patent application that relate to its strength of patentability in categories such as novelty, obviousness, and usefulness.

Plug-in—includes any software application or module or one or more computer instructions, which may or may not be in communication with other software applications or modules, and may include any file, image, graphic, icon, audio, video or any other attachment. Plug-ins may be comprised of any one or more set of computer instructions using any computer programming language.

Relevancy—includes how relevant a word, phrase, patent section, patent figure or document is to another word, phrase, patent section, patent figure or document

Rules—includes computer instructions that can provide application direction and/or decision making and includes both inference and reactive rules. Rules may include permissions, limitations, method steps, alert event conditions, alert contents, workflow instructions, security measures, business process management instructions, if/then/else instructions and/or any supporting data, variables, or computing instructions and/or logic.

Rules Based—includes any system or application or module that uses or relies on one or more rules.

Search Relevancy—includes how relevant sections of a document are to a word, phrase, patent section, patent figure, or document are when producing search results for a query. For example, the abstract of a patent document can have higher search relevancy than the background of a patent document when conducting prior art searches using a prior art search software tool.

Search Weight—shall mean the score that one section of a document has to other sections of a document when conducting searches against a database of documents in which that document is included.

Subclass—includes a subclass of patent documents as defined by the USPTO. Subclass can also include any sub classification of a database of electronic documents.

Synonym—is any word or group of words that have the same or similar meaning of another word or group of words and/or that may be interchangeable. The opposite of synonym is antonym.

Thesaurus—includes an electronic database of words that have been mapped to indicate similarities in word definitions. The thesaurus may be broken into classes and subclasses that relate to the classes and subclasses of documents stored in an electronic database and/or accessed via such database

Virtual—includes anything that is not real, in whole or in part, and/or anything real, in whole or in part; which may be simulated, represented, presented or depicted in a virtual environment, video game or displayed on a screen.

Virtual Environment—any technology that permits one or more end users to interact with a real, imaginary or virtual computer simulated environment.

Virtual World—includes a world created in an online game such as World of Warcraft, or a virtual community such as Second Life, Eve or There.com

Video Game—shall mean any massive multi online player game such as World of Warcraft and any virtual world such as Second Life

Web page—includes any resource, form, or any information that is accessible via the Internet and that is suitable or exists on the world wide web. A web page usually includes information in any applicable format, e.g., HTML or XHTML. Web pages may include hyperlinks or provide other means of navigation to other web pages. Web pages may be accessed by any applicable means, including, but not limited to: any computing or internet enabled devices, e.g., personal computers, laptops, PDAs, cell phones, video game controllers, or any other communications device, which may be local or remote to the computer or server where such web page(s) may exist or reside.

Word—includes one or more groups of letters including titles, indices, text, headings, descriptions, diagrams, etc., and documents (in whole or in part), phrases (i.e., groups of two or more words), synonyms, antonyms, icons, graphics, drawings, schematics, blueprints, pictures, audio and/or video, and/or any combination of the forgoing, The words “Word” and “Words” shall have corollary meanings.

As stated above, the present disclosure provides methods and systems to allow end users to attach notes to electronic documents. The notes may be stored and accessed via any applicable means. For example, the notes may be stored within particular sections or parts of the document(s) or applications and/or stored in a separate database or table designed for such purposes and a link or pointer and/or hyperlink can be stored with the note that provides a link or index or key that provides access to or recall of the original or subsequently modified electronic document. Notes, regardless of where or how they are stored, can be searched and/or accessed by end users, e.g., authorized end users, merchants, patent attorneys, patent examiners, etc., and search engine spiders and/or crawlers or other search engine tools.

According to an embodiment, search engine spiders can use the notes to find an initial document and/or other documents that relate to the initial document or set up and/or create new or revised documents based on the notes provided and/or the initial and/or any subsequently linked documents.

Methods to create web pages, hyperlinks and hypertext are well known in the prior art and any person with ordinary skill in the art can design and create such hyperlinks. Methods to design and create hypertext and/or hyperlinks are discussed and disclosed by the authors of the following reference and other materials, including, for example: “Intelligent Hypertext: Advanced Techniques for the World Wide Web (Lecture Notes in Computer Science), by Charles Nicholas and James Mayfield,” “Information Architecture for the World Wide Web: Designing Large-Scale Web Sites [ILLUSTRATED], by Louis Rosenfeld (Author), Peter Morville,” Creating Web Pages with HTML Simplified, by Sherry Willard Kinkoph (Author),” “Master Visually Web Design (With CD-ROM) by Carrie F. Gatlin and Michael S. Toot,” and “Creating Internet Intelligence: Wild Computing, Distributed Digital Consciousness, and the Emerging Global Brain (IFSR International Series on Systems Science and Engineering), by Ben Goertzel.” Each of the above is hereby incorporated by reference.

In an embodiment, the system disclosed herein permits an end user to attach a note to one or more software applications, documents or other electronic media. Such notes may be free form text and/or may include information or attachments, including, but not limited to: images, e.g., GIF; audio, e.g., MP3; video, e.g., JPEG; or other file types, e.g., PDF, MS Word Documents, documents, figures, icons, etc. End users and/or automated systems may attach and/or access and/or make use of electronic notes.

According to various embodiments, creation of a note may be accomplished by any applicable means, including, for example, using a word processor or other text editor or application designed for such purposes, including, but not limited to any applicable file translation program, including any import or export programs, audio editor and/or image or video editors, etc., such as Microsoft's Word, Excel, PowerPoint, or Adobe's Photoshop, Audio Dementia by Holliday Audio, or any other editors that are known within the art, or any future editors that provide a means to enter any one or more of text, audio, video, pictures, or other data elements or types and/or any combination of the forgoing.

According to various embodiments, attachment of a note to a document may be accomplished by any applicable means, including, for example, via a user interface that permits the entry of text and/or the attachment of one or more files or notes, and/or by permitting an end user or a system to establish or create a hyperlink from the source document or application or module to the note or vice versa, and/or inserting a link, such as a hyperlink into the source document, application or module, and/or to a table or database associated with the document, application or module, or the specific entries within a document, for example an index, and/or the note.

Additionally or alternatively, a centralized or other system may be established for such purposes so as to permit a record of source document materials, applications, modules and/or notes to be cataloged and/or indexed and/or stored, and/or categorized and/or organized by any available or applicable means.

In certain embodiments, if a first end user modifies or submits notes, regarding a figure, document or other information that was created by or modified by a second end users, the second end user may be notified of any or all notes or modifications, whether proposed, pending, or approved. Such notification may be accomplished by any applicable means, including, for example, using an alert. Alerts may be sent via any applicable means. Exemplary methods to determine alert events and/or to send alerts are disclosed for example, in U.S. patent application Ser. No. 11/676,848 “Virtual Environment with Alerts” filed Feb. 20, 2007 which is incorporated herein by reference.

By creating such links or hyperlinks in or between or otherwise associated with any one or more such source documents, applications, or modules, the disclosed system permits one or more end users to associate notes with any number of documents, applications, or modules, that may or may not be under the direct control of a system owned or operated by the end user.

End users may include virtually anything within or link to from one or more notes. For example, notes might include any one or more of the following, including, but not limited to:
1. Commentary about the source/initial document, or software or application or module.
2. Supporting or detracting information about the source/initial document, application or module
3. Historical data or information
4. Hyperlinks to other notes, web pages, documents, databases, tables, indices, etc.
5. Images, files, or other content or attachments, including other software applications, modules and source code
6. Ratings, weighting factors, grades, or scores regarding the source initial or any other document, application or module and/or other notes, and/or any end user
7. Biographical information regarding the author(s) of the source/initial document, application, or module and/or any one or more authors of notes or any other interested parties
8. Electronic signatures
9. Computer programs that may be inserted or otherwise associated with a document, application or module and/or note. The program may be activated by any applicable means, including, but not limited to:
   a. When a the source/initial or any other related document and/or note and/or any of its attachments are clicked, accessed, indexed, transmitted, examined, e.g., by a WebCrawler or spider, opened, viewed, moved, deleted, expanded or modified
   b. When a date or time occurs, or approaches or elapses
   c. When an alert is sent or received
   d. When an alert event occurs or fails to occur
   e. When an icon or menu option is presented and selected by an end user to activate such a program;
   f. any combination of the above
10. Notes about or hyperlinks to other notes
11. Error messages, error logs, methods to recreate or workaround errors or other debugging information, techniques, tools and/or software or code that may correct or mitigate any such error messages or errors.
12. Or any combination of the above.

According to various embodiments, notes may contain multiple entries by one or more end users and/or automated entries made by one or more automated methods. For example, when reviewing a patent database, end users may attach multiple comments to one or more patents. Within or relating to any one or group of patents, such end users, e.g., patent examiners, patent attorneys, inventors (e.g., the original inventor and/or competing inventors or other inventors), or other third parties, may desire to comment on a patent or patent pending, and/or comment on a comment, e.g., add a note to an existing note.

According to various embodiments, a note may include other notes. In certain embodiments, there may be a limit as to the number and/or type of end user(s) that may:
1. Create a new note
2. Add to or modify a note
3. Delete a note
4. Insert a note within a note
5. Insert or modify a hyperlink within a document or a note
6. Any combination of the above

According to some embodiments, when a document contains multiple notes and or one or more notes with multiple entries, the notes and/or entries within the notes may be organized and/or prioritized by any applicable means, including, but not limited to:
1. One or more attributes of the end user, creator, or entity that created or modified a note or an entry within a note, or entry or modification of an entry in the document. Suitable attributes include, but are not limited to: the author's qualifications, e.g., a patent examiner's notes may be sorted or ranked higher than those of a third party inventor; age; education; reputation; or by any other applicable means.
2. Payment of a fee. Priority ranking of multiple entries may be accomplished by the author or end user paying a fee to receive higher priority or visibility of one or more notes or entries. Exemplary methods for priority queuing documents are disclosed for example in U.S. patent application Ser. Nos. 11/462,621, “Fee-Based Priority Queuing for Insurance Claim Processing,” filed Aug. 4, 2006; Ser. No. 11/611,024 “System and Method for Prioritizing Items in a Queue” filed Dec. 14, 2006; and PCT Application No. PCT/US06/340347, “Insurance Form Priority Queuing;” each of which are incorporated herein by reference.
3. Based upon a relevancy score. A relevancy score may be determined based upon feedback provided by the document's and/or note's original author and/or any number of end users that are authorized to provide such ranking or scores, e.g., based upon feedback regarding an author of a document or note over time or multiple occurrences or reviews. In other embodiments, relevancy scores may be determined, in whole or in part, through the use of automated means. In addition to the novel relevancy ranking and scoring methods disclosed herein, other methods to determine relevancy between and among documents and/or websites are well known within the prior art, including, for example, the methods discussed in the book entitled “Text Databases and Document Management: Theory and Practice, by Amita Goyal Chin, which is hereby incorporated by reference.
4. By date and time stamp. For example, notes received or entered earlier than other notes may appear at the top of the list, while older notes may appear at the bottom of the list, or vice versa.
5. Alphabetically by end user name.
6. By topic, e.g., alphabetical or numerical.
7. Any combination of the above, e.g., sorted first by date, then by end user name.

Interested and/or authorized end users or third parties may access the notes via any applicable means, including:
1. Via an interface that is associated with the source document, e.g., using the same or similar editing tools used by the original author. For example, the USPTO offers a tool to permit inventors to submit patent application. Such a tool, or another tool, could be modified to permit inventors and/or other end users to review the patent application, but the end users may or may not be permitted to modify the original or source document. However, (some) end users may be permitted to attach or otherwise associate one or more notes with the patent applications, or sections of the patent application, or specific phrases or words or diagrams or other elements contained within the patent application. For example, a first inventor that has been previously issued a patent may believe that the issued patent should serve as prior art to a second inventor's pending or issued patent. In such a case, the first inventor could attach a note to the second's inventor's pending or issued patent. The note might include information about the first inventor's patent. Relevant information might be, for example: the patent, publication, or application number; some or all of the abstract; explanatory text or recorded audio or video explaining why the patent or application should serve as prior art; and/or any other information. For example, an interested third party may submit a note to an issued or pending patent providing evidence that the issued or pending patent is obvious in light of an existing device or method. Evidence may be provided by including references, hyperlinks or other information directly in the note, and/or by providing information about where the information could be retrieved. This information could then be further investigated by a patent examiner or other third parties.
2. Via a separate program designed and built for such purpose. For example, a separate application that includes a user interface that permits the creation of notes and/or the inclusion of attachments, documents or hyperlinks, may be provided to end users. Using such an application and interface, end users may create one or more notes and then, subsequently attach such notes to one or more documents, or portions of documents, or phrases or text or words within a document. For example, after creating a note, and end user might include a hyperlink in the note that links to the source document or document in question. In this fashion, the original document need not be affected, nor is any direct interface or authorization required or necessary from the owner of the source document or the system on which the source document may be stored, unless such system includes protective measures, such as encryption or password or other security. In such cases, permission may be required, and may be granted as a matter of course, due to a preexisting or otherwise negotiated agreement between the source document owner and or server owner and/or via automated means such as by using an API (application program interface) constructed for such purpose.
3. Or, end users may submit notes to a service bureau or automated system or appointed body of one or more individuals that have been duly authorized to accept such notes and either review or approve or submit such notes to the document. For example, end users may create notes by any applicable means, e.g., a word processor, such as Microsoft's Word application. By submitting a note in an MS Word document, a system or person or group of people could examine the document and attach notes to the desired source document. To accomplish this, the document might include information about the source document and the subject matter or purpose of the a note. The note may contain any other useful or pertinent or other information as required or desired by any one or more of the original or source document's author, the computer application or system and/or by a review body. Such rules and requirements may be established by any applicable means including, for example, by the system that controls the documents and/or notes, and/or by agreement between the affected parties, and/or by rule or law and/or by rules established by a review committee, or any combination of the above.

In certain embodiments, when end users access documents and/or notes, they may choose to use a sort and/or filtering application or program configured to sort, identify and/or select documents and/or notes and/or portions thereof using criteria or options provided by any suitable entity, including, for example, the end user. Filtering and sorting options may be implemented by any applicable means. Filtering and sorting options may include, sorting and/or filtering by any one or more variables or known data or attributes, including, but not limited to: author; date; time; date/time submitted or reviewed; date/time approved; any other date/time data; subject; application number; relevancy; number of attachments; ranking; relevancy; or other score; or any combination of the above.

In certain embodiments, notes may be limited to and/or include advertising messages or other marketing content. Methods for providing notes or advertising, including charging for such notes or advertising, including the rental, license, purchase or placement of hyperlinks or other applications, modules or other information in such documents are disclosed in U.S. patent application Ser. No. 11/668,586 “Targeted Advertising Based on Invention Disclosures,” filed Jan. 30, 2007; Ser. No. 11/668,596, “Keyword Advertising in Invention Disclosure Documents,” filed Jan. 30, 2007; ______ (Attorney docket No. 3303103) “Merchant Tool for Embedding Advertisement Hyperlinks to Words in a Database of Documents” filed Apr. 6, 2007; and ______ (Attorney docket No. 3303104) “Merchant Tool for Embedding Advertisement Hyperlinks to Words in a Database of Documents,” filed Apr. 6, 2007; each of which is hereby incorporated by reference.

In certain embodiments, before displaying an advertisement and/or before presenting a list of words and/or documents, e.g., from a lexicon of words, it may be desirable to ascertain certain additional information about such advertisement and/or request for information. In such cases, the system may determine that it is necessary, desirable, or generally useful to present one or more survey questions to aid in determining which words, documents, or other information should be presented, e.g., to help determine which advertisement might yield generally better results, and/or which word or synonym is generally more relevant given the information known about the end user and/or collected by using and/or displaying and/or gathering results from one or more such survey questions. For example, when an end user enters the word “case” into a search tool designed to retrieve a definition of such word or words, the system might ask the end user the following question or questions: e.g., are you an attorney, are you interested in travel, or are you seeking legal advice. Based upon the end user's response, e.g., if the end user responded in the affirmative to the last question, the system might either provide a definition of case to include legal cases, and/or the system may also provide an advertisement for one or more attorneys seeking clients. Based upon the response to one or more questions, the system may present additional qualifying questions, i.e., additional questions to further narrow the search results and or the sort display results. Exemplary methods to provide for survey questions and gathering of data are disclosed by applicants in U.S. Patent Application Ser. No. 60/774,177, entitled “Survey Based Qualification of Keyword Searches,” Ser. No. 11/278,123, also entitled “Survey Based Qualification of Keyword Searches” Ser. No. 11/562,738 “Survey Based Qualification of Keyword Searches” and Ser. No. 11/608,150, entitled “Map and Inventory Based On-Line Purchases” which applications are incorporated herein by this reference.

According to some embodiments, end users can create a name for a title of a document. The search engine looks for other documents that refer to that name and provides links to them as part of the guided user interface (GUI) when displaying that document.

According to another embodiment, end users can also link articles to a document. For example, an interested third party or end user may wish to submit a magazine article to a patent examiner that is presently reviewing a patent application. Such submission may be in the form of a note, which may be attached to a patent application such as a web page that displays the patent application. The note may include a hyperlink to the magazine article.

In another embodiment, the system could compare two or more notes and remove or delete duplicate entries, and/or reference the two and/or sort them such that they appear generally adjacent to one another.

According to some embodiments, notes contributed to different sections of a patent may have different relevance weights for subsequent searches by end users and search crawlers or spiders. For example, notes contained within the prior art and claims sections may carry a generally higher weight or ranking than notes associated with the abstract section of the patent application.

According to an embodiment, the number of times a document is downloaded, cross referenced, hyperlinked, or contributed to may have an effect on its search relevance to search spiders and end users and/or to its ranking. For example, if within a single note, there are five hundred entries, but numerous end users repeatedly review entry numbers: 7, 212, and 327, these three entries may be move up partially to the top of the note or to the top of the note. Accordingly, the order of the entries may be dynamic and determined, in whole or in part: by the number of times accessed; the nature or qualifications or other attributes of those accessing such entries, e.g., entries accessed more frequently by a patent examiner may carry more weight than entries accessed by third parties; or other relevant factors.

In some embodiments, certain end users may have special privileges or restrictions regarding access to or use of the notes system and/or one or more of its features and/or benefits. For example, an Inventor/Assignee/Attorney may have a special log in that allows them to post or access notes that other end users or third parties cannot post or access. The system may be configured to validate that the end user has a special relationship to the document or is otherwise authorized to perform a given task and provide advanced editing, note adding, or other, privileges/restrictions to that end user. Suitable privileges and/or restrictions may include, but are not limited to, the ability to:
a. Log into the hyperlink, document or note creation or editing program(s);
b. Access to or the ability to create and/or submit a hyperlink, source document, or note;
c. Make changes or delete a hyperlink, source document, or note;
d. Rank or score a document or note;
e. Provide biographical information;
f. Provide supporting or detracting information, documents, hyperlinks, or notes, to any hyperlink, document, or note or any combination of these;
g. Establish, modify, submit, or review rules, regulations, or programs that control submission of documents, hyperlinks, rules, or other information or programs;
h. Establish, create, or otherwise determine, a price, fee, or tax, to be levied, accrued, charged or otherwise collected relating to any submission of any document, hyperlink, etc.;
i. Any combination of the above.

In another embodiment, the system can permit an end user to attach a note to a group of documents. For example, in addition to providing a note that is associated with a single patent, an end user can select a group of patents provide notes for the group of patent. Furthermore, the notes may be associated with each of the patents in the group, or only with sections of each patent in the group. In this fashion, a single note or part of a note can be simultaneously associated with or linked to more than one document.

In certain embodiments, all notes, hyperlinks, entries, and revisions may be time and date stamped. Furthermore, changes to the document or notes associated with the note may be tracked. The time and date stamp and change tracking may be encrypted to prevent unauthorized or fraudulent modifications. By time stamping and tracking changes, authorized end users could determine the various states of any such definitions, notes, images, video, audio, documents, or text, etc., at the time of each such change, update or modification. In this fashion, the priority of ideas, e.g., within a patent application may be determined by an authorized end user, e.g., a patent examiner or a court of competent jurisdiction. In addition or in the alternate, various copies of the data as it is changed or updated may be time stamped, and stored.

According to another embodiment, Spiders or WebCrawlers or other applications that scan documents or web pages, can comb through, i.e., examine, digital articles and documents and create notes for a document based on how the document is discussed in other documents and/or notes.

In certain embodiments, end users may desire to search notes, words, documents or databases to find notes, words, documents, that may require lexicon updates and/or definitions, synonyms and/or antonyms. Exemplary methods for providing patent and prior art searches are disclosed in U.S. patent application Ser. No. 11/671,380, “Automated Patent Searches” filed Feb. 5, 2007; Ser. No. 11/693,555 “Providing Certified Patent Searches Conducted by Third Party Researchers” filed Mar. 29, 2007; and ______ (Attorney docket No. 3304103) entitled “Enhanced Patent Prior Art Search Engine,” filed Apr. 6, 2007; each of which is hereby incorporated by reference.

In other embodiments, end users may desire to file and/or update documents, e.g., patents, using web based tools via the Internet. An exemplary tool for preparing submitting documents via the Internet is disclosed for example, in U.S. patent application Ser. No. 11/627,263 “Automated Web-Based Application Preparation and Submission” filed Jan. 25, 2007, which is incorporated herein by reference.

In certain embodiments, surveys, notes, advertisements and hyperlinks may be interchangeable terms, e.g., a survey can be a note, and a note can be a survey or a survey can include an advertisement or vice versa.

In certain embodiments, the disclosed invention may be practiced in the real or virtual world. For example, a video game may include a virtual patent office. Exemplary methods and systems for providing protection of intellectual property in a virtual environment are disclosed, for example, in U.S. patent application Ser. No. 11/428,263, “Video Game Environment” filed Jun. 30, 2006; Ser. No. 11/620,563 “Copyright of Digital Works in a Virtual Environment,” filed Jan. 5, 2007; Ser. No. 11/689,977, “Digital Rights Management in a Virtual Environment,” filed Mar. 22, 2007; Ser. No. 11/671,373 “Video Game with Control of Quantities of Raw Materials” filed Feb. 5, 2007; Ser. No. 11/680,960 “System for the Creation and Registration of Ideas and Concepts in a Virtual Environment,” filed Mar. 1, 2007; each of which is incorporated herein by reference. Accordingly, notes, such as those disclosed herein may be created, used and/or delivered in a virtual world application, such as a virtual patent office. As such, notes may be used to provide game owners and or game players or player characters with information about any virtual object, business, transaction, or anything else.

For example, notes could be used for the creation of agreements between or among real or virtual end users, players, or other third parties. In such cases, methods to ensure that agreements are enforceable and that advertising fees are collected in such virtual environments are desirable. Exemplary methods for providing such contract enforcement and collection of fees are disclosed, for example, in U.S. patent application Ser. No. 11/279,991 “Securing Virtual Contracts with Credit,” filed Apr. 17, 2006; Ser. No. 11/624,662 “Securing Contracts in a Virtual World,” filed Jan. 18, 2007; Ser. No. 11/559158 “Financing Options in a Virtual World” filed Nov. 13, 2006; Ser. No. 11620,542 “Satisfaction of Financial Obligations in a Virtual Environment Via Virtual and Real World Currency,” filed Jan. 5, 2007; Ser. No. 11/421,025 “Financial Institutions and Instruments in a Virtual Environment,” filed May 30, 2006, and Ser. No. 11/380,489 “Multiple Purchase Options for Virtual Purchases,” filed Apr. 27, 2006; each of which are hereby incorporated herein by reference.

In other embodiments, notes may be used to describe a product, goods, or service required by one player and to be provided by another player. Notes may also be used to provide feedback regarding game play, enjoyment, features, desired features, discovered errors, and/or any other form of communication and/or ranking information.

It will be understood that all embodiments herein which refer to a patent are equally applicable to a patent application, and vice versa, unless explicitly stated otherwise with respect to a particular embodiment. Any reference to a patent (or to a patent application) is for reasons of brevity only.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

Accordingly, the presently described system may comprise a plurality of various hardware and/or software components such as those described below. It will be appreciated that for ease of description, the variously described hardware and software components are described and named according to various functions that it is contemplated may be performed by one or more software or hardware components within the system. However, it will be understood that the system may incorporate any number of programs configured to perform any number of functions including, but in no way limited to those described below. Furthermore, it should be understood that while, for ease of description, multiple programs and multiple databases are described, the various functions and/or databases may, in fact, be part of a single program or multiple programs running in one or more locations.

Accordingly, exemplary programs include:
1. Primary Application
2. Document Search/Indexing/Mapping Program
3. Word Search/Indexing/Mapping Program
4. Note Attachment Program
5. Note Modification Program
6. Note Access/Use Program
7. Find Like Documents Program
8. Note Relevance Program
9. Billing Program
10. Collections Program
11. Alerts Program

Exemplary database architecture includes:

Word Database
1. Word ID
   a. Word Count ID
   b. Word
   c. Primary Definition

Hyperlinks 1-N (e.g., sources/locations of use)
a. Alternative Definitions 1-N
   1. Definition
   2. Supplied By-ID
   3. Hyperlinks 1-N
2. Synonym ID—1-N
3. Synonym
4. Word ID
5. Relevancy Scores 1-N
6. Primary Score %
7. Alternative Score %'s 1-N
   a. Antonym ID—1-N
      1. Antonym
      2. Word ID
8. Relevancy Scores 1-N
9. Primary Score %
10. Alternative Score %'s 1-N
   a. Notes 1-N
      1. Note ID
      2. Note Short Description
      3. Note Long Description
      b Narrative Text
      5. Attachment Hyperlinks 1-N
      6. Where Used Hyperlinks 1-N
   b. Figure IDs 1-N
   c. Change Tracking ID 1-N

Change Tracking Database
1. Change Tracking ID
2. Word ID
3. Change Type (e.g., Add, change, delete)
4. Change Description
5. Date/Time
6. User ID
7. Before Image
8. After Image
9. Relevancy or score
10. Notes 1-N

Figure Database
1. Figure ID
2. Figure Description
3. Figure or Attachment
4. Submitted By ID
5. Source ID
6. Editor Application ID
7. Document/Patent Application Where Used ID 1-N
8. Hyperlinks 1-N
9. Notes 1-N

Document Database
1. Document ID
2. Document Description
3. Document Owner ID
4. Hyperlinks (e.g., document locations) 1-N
5. Class 1-N
6. Subclass 1-N
7. Type 1-N
8. Subtype 1-N
9. Date/Time Stamps
   a. Submitted/Found/Indexed On
   b. Submitted/Found/Indexed By ID or Hyperlink
   c. Revised On 1-N
   d. Revised By 1-N
   e. Before Image 1-N
   f. After Image 1-N
   g. Notes 1-N

Advertiser or Notes Owner Database
1. Advertiser/Owner ID
2. Advertiser/Owner Name
3. Classes of Trade 1-N
4. Advertiser/Owner Financial Information
   a. Billing Method ID
   b. Credit Card Information
      1. Preferred Card Number
      2. Preferred Card Holder
      3. Preferred Card Type
      4. Name
      5. Expiration Date
      6. Security Code
   c. Additional Cards 1-N
      1. Card Number
      2. Card Holder (e.g., Bank Name)
      3. Card Type (e.g., Visa)
      4. Name
      5. Expiration Date
      6. Security Code
5. Advertiser/Note Owner Mailing Address
6. Advertiser/Note Owner Rules Database
   a. Rule ID 1-N
      1. Word(s)/Documents Applied To 1-N
7. Rule Description
   1. Rules 1-N
   2. Billing Terms and Conditions ID 1-N
8. Advertiser/Note Owner Attorney of Record
9. Attorney ID 1-N
10. Advertiser/Note Owner Qualifications 1-N
11. Notes 1-N

Advertiser/Note Owner Qualifications Database
1. Qualification ID
2. Description
3. Qualification Type
4. Years Experience
5. Fields of Use Applicable 1-N
6. Notes 1-N

Attorney Database
a. Attorney ID
b. Name
c. Address
d. Description

Notes 1-N

Billing Terms and Conditions Database
1. Billing Method ID
2. Billing Type
3. Description
4. Billing Frequency
5. Due by # days
6. Late by # days
7. Interest Rate Fixed
8. Interest Rate Variable
9. Interest Accrues after days
10. Notes 1-N

Accounts Receivable Database
1. Advertiser/Note Owner ID
2. Total Amount Owed
3. Transaction Detail Records 1-N
4. Date of Transaction
5. Type
6. Advertisement ID
7. Word ID
8. Hyperlinks 1-N
9. Amount per impression or click through
10. Notes 1-N

Search Database
1. Document ID
2. Document Location/Hyperlink
3. Notes 1-N

Transaction Database
1. Transaction ID
2. Description
3. Date/Time
4. Type
5. Advertiser/Note Owner ID
6. Advertisement/Note Owner Rules Used 1-N
7. Billing T&C's 1-N
8. Billing Method ID
9. Transaction Amount
10. Notes 1-N
11. Results 1-N
   a. Note Added, Changed, Deleted, and/or Accessed
12. Hyperlink Clicked
13. Sub-Hyperlinks Clicked 1-N
   a. Advertisement/Note and/or Webpage) Displayed 1-N
14. Click Through y/n
15. Duration of view
   a. Conversion y/n
   b. Conversion dollar amount

Advertisement Database
1. Advertisement ID
2. Advertiser ID
3. Description
4. Words 1-N
5. Documents 1-N
6. Hyperlinks 1-N
7. Advertising Content File 1-N
8. Notes ID 1-N

Document Class Database
1. Class ID
2. Description
3. Notes 1-N

Document Sub Class Database
1. Subclass ID
2. Description
3. Notes 1-N

Document Type Database
1. Type ID
2. Description
3. Notes 1-N

Document Sub Type Database
1. Subtype ID
2. Description
3. Notes 1-N

Group Database
1. Group ID
2. Description
3. Notes 1-N

Advertisement Type Database
1. Type ID
2. Description
3. Notes 1-N

Word Count Database
1. Word ID
2. Number of Occurrences
3. Hyperlinks 1-N
4. Notes 1-N

Survey Database
1. Survey ID
2. Survey Description
3. Advertiser ID
4. Survey Question ID 1-N
5. Question
6. Answer Options 1-N
7. Notes 1-N

Results Database
1. Result ID
2. End User ID
3. Survey Questions 1-N
4. Survey Answers 1-N
5. Date/Time Stamp
6. Narrative or Text Responses 1-N
7. Notes 1-N

Rules Database
1. Rule ID
2. Rule Description
3. Rules 1-N
4. Notes 1-N

Search and Survey Database

Word Descriptor Database

Notes Database
1. Note ID
2. Hyperlinks 1-N
3. Note Description Short
4. Note Description Long
5. Note Group ID
6. Note Class ID
7. Note Subclass ID
8. Note and/or Note Attachments 1-N
9. Owner/Submitted By ID
10. Original Submission Date/Time
11. Notes 1-N
12. Modifications 1-N
13. Owner/Submitted By ID
14. Modification Submission Date
15. Short Description
16. Long Description
17. Owner/Submitted By ID
18. Original Submission Date/Time
19. Hyperlinks 1-N
20. Change Image 1-N
   a. Before Change
   b. After Change
      1. Notes 1-N

Suppression Rules Database

Hyperlink Database
1. Hyperlink ID
2. Hyperlink
3. Description
4. Owner ID
5. Advertiser ID
6. Notes 1-N

User Database
1. User ID
2. Name
3. Account Type
4. Description
5. Terms and Conditions ID
6. Text
7. Notes 1-N

Document Group Database
1. Group ID
   a. Description
   b. Includes Sub-Groups/Sub-Class IDs 1-N
   c. Notes 1-N
2. Document Class
   a. Class ID
   b. Description
   c. Includes Sub-Class IDs 1-N
   d. Notes 1-N
3. Document Sub Class
   a. Subclass ID
   b. Description
   c. Notes 1-N
   d. Note Class
4. Note Class ID
   a. Description
   b. Includes Sub-Class IDs 1-N
   c. Notes 1-N
5. Note Subclass
   a. Note Subclass ID
   b. Description
   c. Notes 1-N

Nick Name Database
1. Nick Name ID
2. Nick Name (Short Description)
3. Nick Name (Long Description)
4. Patent or Document Number
5. Notes 1-N

Patent Application or Document ID Database
1. Patent Application or Document ID
2. Application Serial Number
3. Pending Application Number
4. Issued Patent Number
5. Patent Applicant Name(s) 1-N
6. Applicant, i.e., User ID
7. Inventor City
8. Inventor State
9. Inventor Country
10. Assignee Name
11. Assignee City
12. Assignee State
13. Assignee Country
14. Title
15. Abstract
16. Application Date
17. Short Description
18. Long Description
19. Claims
20. Attorney or Agent Name
21. Attorney or Agent ID
22. Specifications/Descriptions
23. Filed of Use
24. Current US Classification
25. Current International Classification
26. Primary Examiner
27. Assistant Examiner
28. Parent Case Information
29. Related Application Data (e.g. US)
30. Referenced By
31. Reissue Data
32. Foreign References
33. Foreign Priority
34. Other References
35. PCT Information
36. Government Interest
37. Application Type
38. Hyperlinks (e.g., document locations) 1-N
39. Class 1-N
40. Subclass 1-N
41. Type 1-N
42. Subtype 1-N
43. Notes 1-N
44. Additional Date/Time Stamps/Change Tracking Data
45. Submitted/Found/Indexed On
46. Submitted/Found/Indexed By ID or Hyperlink
47. Published y/n
48. Published Date
49. Revised On 1-N
50. Revised By 1-N
51. Before Image 1-N
52. After Image 1-N
53. Rejected/Issued?
54. Rejected/Issued Date
   a. Notes 1-N

Alert Event Rules Database
1. Alert Event Rule ID
2. Alert Event Description
3. Alert Event Rules 1-N
   a. Event Condition
   b. Alert Recipient ID 1-N
      1. Alert Method 1-N
   c. Alert Database ID 1-N
4. Notes 1-N

Alert Database
1. Alert Database ID
2. Alert Contents, one or more of:
   a. Text
   b. Variable Data
   c. Executable
3. Notes 1-N

Alert Methods Database
a. Alert Method ID
b. Method Type
2. Delivery Method (cell phone, pager, e-mail, PDA, database, executable, etc.)
3. Notes 1-N

Alert Recipient Database
a. Alert Recipient ID (e.g., end user ID)
b. Description
c. Alert Method Preferences ID 1-N
2. Notes 1-N

It will be appreciated that the various software and hardware components described above will be configured to perform a variety of functions and methods. Listed below are some exemplary methods that might be performed by the systems as described herein:

LoadText
a. Receive a request to add a note to a document including document section
b. Output add note form
c. Receive note
d. Store note

Look Up Text Via Nick Name Database
a. Receive a search term
b. Determine if documents in the nick name database have the search term
c. Output documents in nick name database that have the search term

Create a Hyperlink in the Text from the Nickname to the Patent/Document Database
a. Retrieve nick names
b. Determine documents related to the nick name
c. Create webpage with nick name
d. Create hyperlink from nick name to documents related to the nick name

Add Notes to the Note
a. Receive a request to add a note to a previously submitted note
b. Output add note form
c. Receive note
d. Store note with previous note

Use Notes to Link Document to Other Documents that Are Relevant to the Note
a. Retrieve a note
b. Determine documents that relate to the note
c. Create webpage with note
d. Create hyperlink from note to documents determined to be relevant to the note.

Filter Notes (automated)
a. Retrieve note
b. Determine documents related to note
c. Create hyperlinks from documents to note

Link Documents to Document Using Notes (Manual)
a. Receive a request to link a document to a note
b. Output link document form
c. Receive document data
d. Link data to note

Determine Relevance of Notes
a. Receive a note
b. Determine documents that relate to note
c. Score documents on degree of relevance to note

Or

Event Driven/Application Model Method Steps

Primary Application/Watchdog
a. Load Database(s)
b. Determine if one or more sub-applications should be executed
c. Execute appropriate sub-applications (see below)
d. Update Database(s)
e. Repeat Process as Necessary/Desired/Indicated

User Interface Application
1. Load database(s)
2. Display graphical user interface for each application/feature as requested/desired
3. Receive input/requests from end users/applications
4. Execute functions as requested/required and/or load additional applications/GUIs
5. Update databases

Security Application
1. Load Database(s)
2. Determine if requested action and/or end user is permitted
3. If not, notify application and/or end user
4. If yes, permit requested step and/or loading of application or other authorized action(s)
5. Update Database(s)

End User Preferences Application
1. Load Databases
2. Present Preferences GUI if required
3. Receive End User Preferences/Feedback/Usage Tracking Information, including:
   a. Filter Criteria or Rules
   b. Sort Criteria or Rules
   c. Relevancy Information
   d. Weighting Factors, Criteria or Rules
   e. Security Preferences
   f. Feedback/Tracking Preferences
   g. Notes
   h. Usage habits/patterns
   i. Display preferences

Opt In/Sign Up Application
1. Load Databases
2. Receiving Indication of new user sign up
3. Record any and all or available information regarding one or more patent applicants and/or applications, end users, examiners, attorneys and/or third parties
4. Update databases

Document Search/Indexing Program
1. Load Database(s)
2. Determine Search/Index Procedure is necessary or desired
3. Search World Wide Web or all accessible or participating or relevant databases
4. Index Documents and Hyperlinks
5. Store Results
6. Update Database(s)

Word Search/Indexing Program
1. Load Database(s)
2. Determine Search/Index Procedure is necessary or desired
3. Search World Wide Web or all accessible or participating databases/words
4. Import or receive or determine synonym/antonyms to words
5. Index Words, synonyms, antonyms, figures and hyperlinks/advertisements
6. Store Results
7. Update Database(s)

Note Attachment Program
1. Load Database(s)
2. Provide Attachment Creation GUI
3. Receive New Note from End User
4. Create Note
5. Create Note Hyperlink
6. Associate Note with Document, Word and/or Hyperlink (as applicable), by, e.g., inserting or otherwise associating Note Hyperlink with Document, Word and/or Hyperlink
7. Update Database(s)

Note Modification Program
1. Load Database(s)
2. Provide Modification GUI
3. Receive Note Change/Delete Request from End User
4. Create Note Modification
5. If required, Create Revised Note Hyperlink
6. Associate Revised Note with Document, Word and/or Hyperlink, by inserting or otherwise associating Note Hyperlink with Document, Word and/or Hyperlink
7. Else, if required, delete Note Hyperlink
8. Update Database(s)

Note Access/Use Program
1. Load Database(s)
2. Provide Access/Use GUI
3. Receive note access/use/activation request from end user (or application)
4. Apply Relevancy Filter (if applicable/requested/desired)
5. Determine action steps, e.g., execute program or hyperlink:
   a. If applicable, perform one or more of the following:
      1. Display appropriate note contents
      2. Display like documents or hyperlinks to like documents, and/or words, hyperlinks, etc.
      3. Execute program or hyperlink
      4. Display document, note and/or advertisement
      5. Open new window to display note contents or advertisement and/or GUI's
      6. Execute note attachment program
6. Update Database(s)

Note Attachment Program
1. Receive indication of new or modified or deleted note and/or advertisement, and/or word, and/or document
2. Load Database(s)
3. If desired, capture before/after change images
4. Create or update or remove hyperlink(s) as required
5. Update database(s)

Find Like Documents, Words, Hyperlinks Program
1. Load database(s)
2. Receive indication a document, word, advertisement, or hyperlink has been indexed
3. Search for relevant documents, notes, or hyperlinks
4. Index results
5. Update database(s)

Note Relevance Program
1. Load Database(s)
2. Receive Relevancy Input from End Users
3. Or use automated application to determine relevancy, e.g., via GA
4. Associate Relevancy with Notes
5. Update Database(s)

Billing Program
1. Load Database(s)
2. Receive indication that billing activity has occurred
3. Determine affected parties, e.g., payer and payee
4. Determine billing rules, terms and conditions
5. Determine billing amounts due
6. Create Invoice and A/P or A/R notices/entries
7. Send Invoices and notices
8. Update Databases
9. Await Payment
10. Receive payment indication
11. Apply payments
12. Notify A/P or A/R systems/and/or affected parties
13. Determine if payments are timely/sufficient
14. If not, execute collections program
15. Update Database(s)

Collections Program
1. Receive indication payments are late and/or insufficient
2. Load Database(s)
3. If applicable, execute one or more of the following steps:
   a. Send late notice
   b. Send insufficient payment or funds notice
   c. Limit or prevent further use until payment terms are partially or fully satisfied, each according to billing terms and conditions and/or rules
   d. Collect funds due from primary and/or secondary credit cards on file.
   e. Notify affected parties
4. Update Database(s)

Alerts Program
1. Load Database(s)
2. Determine if Alert Event has occurred
3. Determine Alert Contents based upon alert rules
4. Determine Alert Recipients and Contents and Delivery Method(s)
5. Send Alert(s)
6. Update Database(s)

Of course it will be appreciated that the systems methods described herein are provided for the purposes of example only and that none of the above systems methods should be interpreted as necessarily requiring any of the disclosed components or steps nor should they be interpreted as necessarily excluding any additional components or steps. Furthermore, it will be understood that while various embodiments are described, such embodiments should not be interpreted as being exclusive of the inclusion of other embodiments or parts of other embodiments.

The invention is described with reference to several embodiments. However, the invention is not limited to the embodiments disclosed, and those of ordinary skill in the art will recognize that the invention is readily applicable to many other diverse embodiments and applications as are reflected in the range of real world financial institutions, instruments and activities. Accordingly, the subject matter of the present disclosure includes all novel and nonobvious combinations and subcombinations of the various systems, methods configurations, embodiments, features, functions, and/or properties disclosed herein.

A reference to “another embodiment” in describing an embodiment does not necessarily imply that the referenced embodiment is mutually exclusive with another embodiment (e.g., an embodiment described before the referenced embodiment), unless expressly specified otherwise.

The terms “include”, “includes”, “including”, “comprising” and variations thereof mean “including but not limited to”, unless expressly specified otherwise.

The term “consisting of” and variations thereof includes “including and limited to”, unless expressly specified otherwise. The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The terms “such as”, “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” may include one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” includes any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the environment described herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. § 1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A method comprising:
providing a database of electronic patent documents;
receiving a note regarding a first patent document from an end user, wherein the note contains comments from the end user related to the content of the first document, but does not alter the appearance or content of the first document;
associating the note with the patent document so that at least some end users who access the original document will also have access to the note.

2. The method of claim 1 wherein the note is related to the patentability of the invention described in the patent document.

3. The method of claim 2 wherein the end user is the inventor.

4. The method of claim 2 wherein the end user is an entity other than the inventor.

5. The method of claim 2 wherein the end user is a patent examiner.

6. The method of claim 1 further comprising:
determining authorized viewers of the note; and
barring access to any user who is not an authorized viewer.

7. The method of claim 6 wherein authorized viewers include the inventor associated with the patent document.

8. The method of claim 6 wherein authorized viewers include the assignee associated with the patent document.

9. The method of claim 6 wherein authorized viewers include the authorized representative of the inventor associated with the patent document.

10. The method of claim 1 further comprising receiving multiple notes associated with the same patent document from multiple end users.

11. The method of claim 10 further comprising sorting the multiple notes based on the date and time the note was submitted.

12. The method of claim 10 further comprising sorting the multiple notes based on the author of each note.

13. The method of claim 12 wherein sorting the multiple notes based on the author of each note comprises determining the relationship of the author to the invention associated with the patent document.

14. The method of claim 13 wherein determining the relationship of the author to the invention associated with the patent document comprises determining if the author is:
an inventor associated with the patent document;
an assignee associated with the patent document;
a representative of an inventor or assignee associated with the patent document;
a patent examiner assigned to the patent document; or
a third party.

15. The method of claim 14 wherein notes authored by an inventor, assignee, representative or an inventor or assignee, or patent examiner, are given preferential display order over notes authored by a third party.

16. The method of claim 10 further comprising:
determining the frequency with which each note is viewed by other end users;
ranking the notes based on the determined frequency.

17. The method of claim 16 further comprising sorting the notes based on the frequency ranking.

18. The method of claim 1 wherein the note contains a hyperlink to another document.

19. The method of claim 18 wherein the other document is identified by the end user as being prior art to the patent document.

20. The method of claim 18 wherein the other document is identified by the end user as being relevant to the patentability of the patent document.
